(19) United States
(12) Patent Application Publication
(10) Pub. No.: US 2013/0054790 A1
(43) Pub. Date: Feb. 28, 2013

(54) SERVER-TEST INTEGRATED APPARATUS FOR ONLINE GAME

(71) Applicants: Kang Min SOHN, Daejeon (KR); Won Taek HWANG, Seoul (KR); Byeong Heon CHO, Seoul (KR); Yong Un OH, Seoul (KR)

(72) Inventors: Kang Min SOHN, Daejeon (KR); Won Taek HWANG, Seoul (KR); Byeong Heon CHO, Seoul (KR); Yong Un OH, Seoul (KR)

(73) Assignees: Kang Min Sohn, Daejeon (KR); Won Taek Hwang, Seoul (KR); SOGWARE, Daejeon (KR); Yong Un Oh, Seoul (KR); Byeong Heon Cho, Seoul (KR)

(21) Appl. No.: 13/253,538

(22) Filed: Oct. 5, 2011

(30) Foreign Application Priority Data
Aug. 26, 2011 (KR) 10-2011-0085530

(51) Int. Cl. G06F 15/173

(52) U.S. Cl. 709/224

(57) ABSTRACT

Provided is a server-test integrated apparatus for online game, which performs a load test with an online game server. The server-test integrated apparatus includes a server module, a server load tester, a packet designer tool, and a metafile processor. The server module provides online service to a client over a network. The packet designer tool defines a packet protocol, and generates a header file for exchanging data between the server module and client, and at least one packet definition file for exchanging data between the server module and server load tester. The metafile processor stores the packet definition file generated by the packet designer tool. The server load tester writes a scenario with the packet definition file to test a load of the server module.

### CROSS-REFERENCE TO RELATED APPLICATION

This application claims priority to Korean Patent Application No. 10-2011-0085530 filed on Aug. 26, 2011 and all the benefits accruing therefrom under 35 U.S.C. §119, the contents of which are incorporated by reference in their entirety.

### BACKGROUND

The present invention relates to a server-test integrated apparatus for online game, and more particularly, to a server-test integrated apparatus for online game, which performs a load test with an online game server.

Online games are games that are played by users which have accessed a server over a network, and defined as games that are simultaneously played by both a user and other users which have accessed a server over a communication network. In Korea, online games of various genres such as Starcraft, Lineage, and Cartrider have succeeded based on good network infra such as provision of ultra high-speed Internet and spread of Personal Computer (PC) rooms, and thus, many companies are doing their best for developing online games.

As developments of online games are largely scaled and the number of users increases, works for assuring the qualities of online games are required for providing stable game services at a large-scale user environment, and companies for developing online games perform a test with their Quality Assurance (QA) team. Game QA teams require experts associated with games, programs, and projects, and verify the stabilities of game services in various fields ranging from project field to program, game play, graphic/sound, and server/network fields. Particularly, since a server/network field requires many human resources and material resources, it is difficult to perform a test with only manpower of a game QA team itself.

Therefore, technology is required for performing a test without human and material resources necessary for performing a large-scale server/network load test.

When developing an online game based on a client and server, a test for stability of an online game server application occupies an important role, and therefore, technology for testing online performance between the client and server is being continuously developed.

Among such technologies, technology that collects packets and reproduces the collected packets into a large-scale load is being researched from various angles. A related art technology uses a scheme using an actual game client, and a scheme where a game client collects packets for communication therewith and reproduces the collected packets in large amounts.

The scheme using an actual game client has a limitation in that high-quality technical human resources are used in an actual test because many operations are performed on program. In the scheme where a game client collects packets for communication therewith and reproduces the collected packets in large amounts, since most of the packets are mainly generated for testing a web server, it is slightly difficult to test interactive applications such as games.

### SUMMARY

The present invention provides a server-test integrated apparatus for online game, which performs a test by applying a packet protocol, which has been designed when generating a server module, to a game server module that is configured with an interactive application a client accesses.

The object of the present invention is not limited to the aforesaid.

According to an embodiment, a server-test integrated apparatus for online game includes: a server module providing online service to a client over a network; a server load tester writing a scenario to test a load of the server module; a packet designer tool defining a packet protocol, and generating a header file for exchanging data between the server module and client, and at least one packet definition file for exchanging data between the server module and server load tester; and a metafile processor storing the packet definition file generated by the packet designer tool, wherein the server load tester writes the scenario with the packet definition file.

The packet designer tool may define a label, a type of the label, and a packet length of the type.

The header file generated by the packet designer tool may be stored in a header file processor.

The server module may receive the header file for accessing the client and the packet definition file for accessing the server load tester, from the packet designer tool.

The server load tester may include: a script generation unit generating a scenario script with a defined packet; a storage unit storing the generated scenario script; and a load generation unit generating a virtual client to generate the load of the server module, according to the scenario script.

The scenario script may be generated by combining the packet definition files.

### BRIEF DESCRIPTION OF THE DRAWINGS

Embodiments can be understood in more detail from the following description taken in conjunction with the accompanying drawings, in which:

FIG. 1 is a block diagram illustrating a server-test integrated apparatus for online game, according to an embodiment;

FIG. 2 is a diagram illustrating an edition operation of a packet designer tool in a server-test integrated apparatus for online game, according to an embodiment;

FIG. 3 is a block diagram illustrating a server load tester of a server-test integrated apparatus for online game, according to an embodiment; and

FIG. 4 is a flowchart illustrating a providing method of a server-test integrated apparatus for online game, according to an embodiment.

### DETAILED DESCRIPTION OF EMBODIMENTS

Preferred embodiments of the present invention will be described below in more detail with reference to the accompanying drawings. In the figures, like reference numerals refer to like elements throughout. Moreover, detailed descriptions related to well-known functions or configurations will be ruled out in order not to unnecessarily obscure subject matters of the present invention.

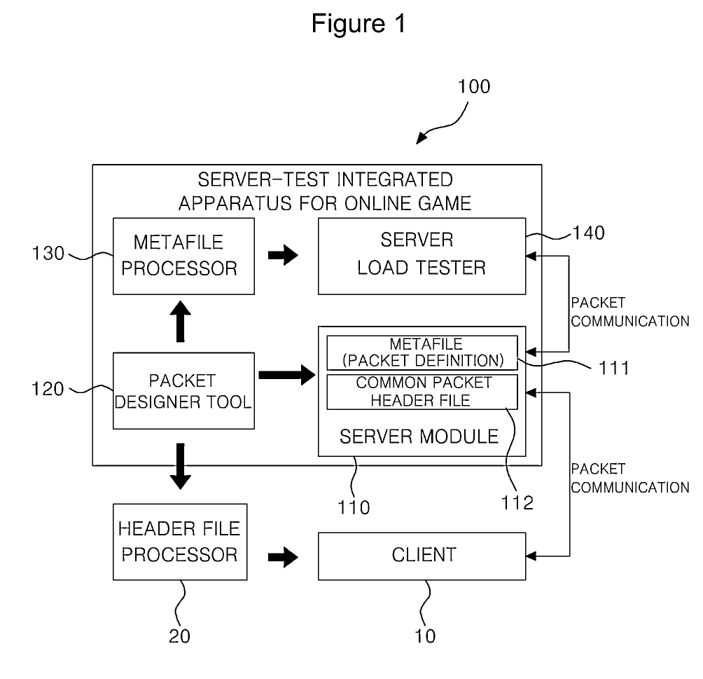

FIG. 1 is a block diagram illustrating a server-test integrated apparatus for online game, according to an embodiment.

Referring to FIG. 1, a server-test integrated apparatus 100 according to an embodiment includes a server module 110, a packet designer tool 120, a metafile processor 130, and a server load tester 140.

The server module 110 provides online service to a client 10 over a network. Herein, the server module 110 may be provided in plurality, for online game service.

In order for the client to access the server module 110 and play a game, the server module 110 stores a common packet header file. The server module 110 stores a packet definition file such that the server load tester 140 accesses the server module 110 and performs a test.

Herein, the client 10 accesses the server module 110 and receives online game service over a network.

The packet designer tool 120 defines a packet protocol, and generates a header file for exchanging data between the server module 110 and client 10 when developing an online game. In this case, the server module 110 and client 10 are capable of performing communication only when having the same information in protocol, and thus, a head file (.h) enabling communication between the server module 110 and client 10 is defined.

The defined header file is stored in the header file processor 20.

Moreover, the packet designer tool 120 generates the packet definition file for exchanging data between the server module 110 and server load tester 140. In this case, since the server load tester 140 accessing the server module 110 serves as a client, the packet definition files is generated for matching a protocol so as to enable packet communication between the server module 110 and server load tester 140.

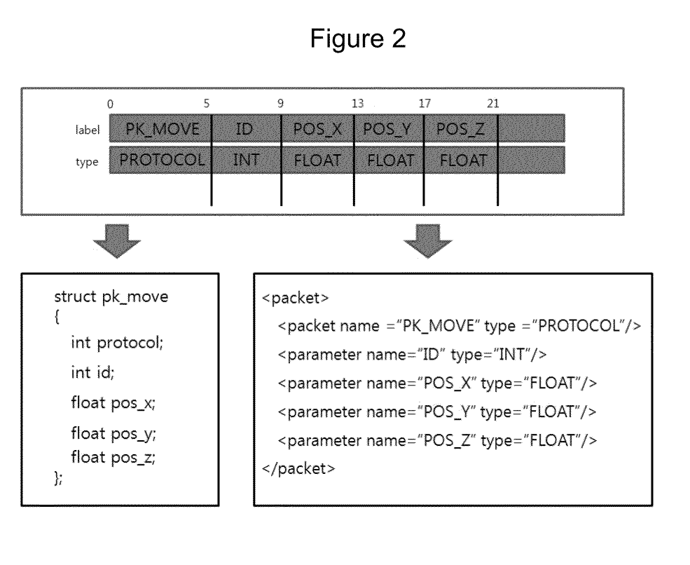

As illustrated in FIG. 2, the packet designer tool 120 designates a label being an element of a packet that is configured by a user through a user interface such as a Graphic User Interface (GUI), a type of the label, and a packet element such as a length of a packet having the type on an online game.

Herein, the designated packet elements are stored in an internal data structure.

The data structure is defined as a header file for the server module 110 and client 10, and defined as a packet definition file for the server module 110 and server load tester 140.

For example, the label being a packet element may be designated as PK_MOVE, ID, POS_X, POS_Y, and POS_Z of FIG. 2. In correspondence with the label, PK_MOVE is designated as PROTOCOL belonging to the type, ID is designated as NT belonging to the type, and each of POS_X, POS_Y, and POS_Z is designated as FLOAT belonging to the type. The packet lengths of the type may be designated as 5 bytes, 4 bytes, 4 bytes, 4 bytes, and 4 bytes, respectively.

In the embodiment, the packet designer tool 120 is defined as a header file (.h) of C/C++ application for communication between the server module 110 and client 10, and defined as a definition file of Extensible Markup Language (XML) for communication between the server module 110 and the sever load tester 140. However, the embodiment is not limited to a specific language.

Accordingly, a header file that is used to communicate with the server module 110 and client 10 with the packet designer tool 120 and a packet definition file used for the server module 110 and sever load tester 130 can be generated and managed unitarily.

Moreover, when generating the server module 110 provided to the client 10, information for a server load test is generated by using the packet designer tool 120, and thus, an automated unit test environment for the stability test of the server module 110 can be built in all stages ranging from an initial development stage to a service stage.

The metafile processor 130 stores the packet definition file generated by the packet designer tool 120.

The server load tester 140 writes a scenario with the packet definition file stored in the metafile processor 130 and tests a load of the server module 110.

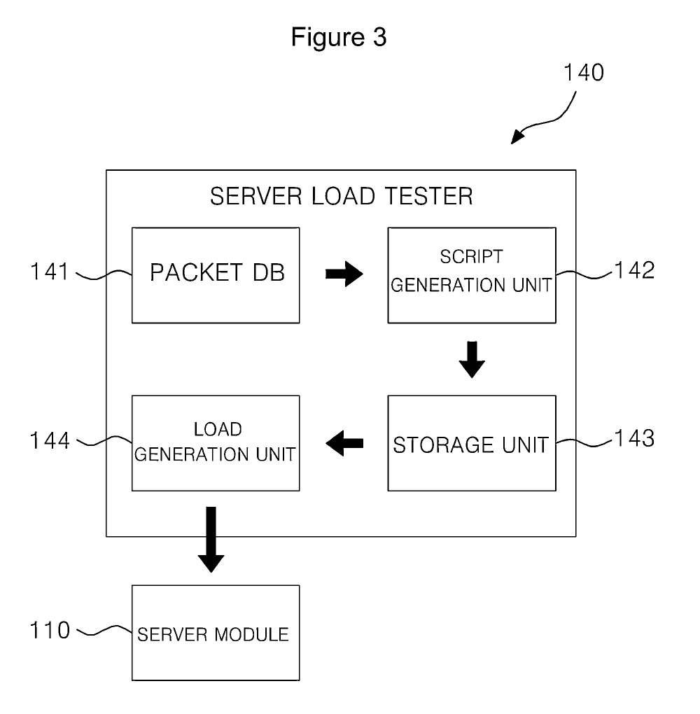

Referring to FIG. 3, the server load tester 140 includes a packet database (DB) 141, a script generation unit 142, a storage unit 143, and a load generation unit 144.

The packet database 141 analyzes a packet on the basis of packet information and stores the analyzed packet on an action-by-action basis.

The script generation unit 142 writes and generates a scenario script with a packet that has been defined for testing online performance between the client 10 and server module 110. In this case, the script generation unit 142 generates the scenario script by combining actions that are stored in the packet database 141.

For example, the script generation unit 142 moves a virtual client to a predetermined coordinate to generates the virtual client as in using a store, and generates the scenario script by combining an action that moves the virtual client to the coordinate and an action that allows a store to be used.

The storage unit 143 stores the generated scenario script. In this case, the storage unit 142 may store the generated script and a result for the load of the server module 110 that has been generated by the load generation unit 144, and moreover, store all necessary information.

In the embodiment, the storage unit 142 is not divided by functions, but all necessary information may be divided and stored.

The load generation unit 144 generates a virtual client according to the scenario script stored in the storage unit 143 to generate the load of the server module 110.

Herein, the virtual client is a client serving as an online game client. The virtual client is recognized as an actual user, in the server module 110, but is a type of dummy client that performs only network communication with the server module 110 without graphic and sound outputs, in a client.

As the virtual client, hundreds of virtual users may be generated for one host, and the virtual client may be controlled by an interface for transferring a simple user command.

The server load tester 140 monitors performance by using feedback based on load generation, and thus predicts the number of uses of a server in contradistinction to the number of simultaneous access users, thereby pretesting the stability of the server module 110. Also, the server load tester 140 analyzes the monitored result and reflects error correction in the server module 110.

Moreover, the sever-test integrated apparatus 100 generates a lot of virtual clients, and thus generates an access in a game server and generates a load in a server. Accordingly, the stability and capacity of the server can be checked with the low cost and a little effort. The server-test integrated apparatus 100 easily controls a virtual user with a simple user interface compared to an actual user that is difficult to directly control, and thus enables the easy reconfiguration of an environment at which various errors occur.

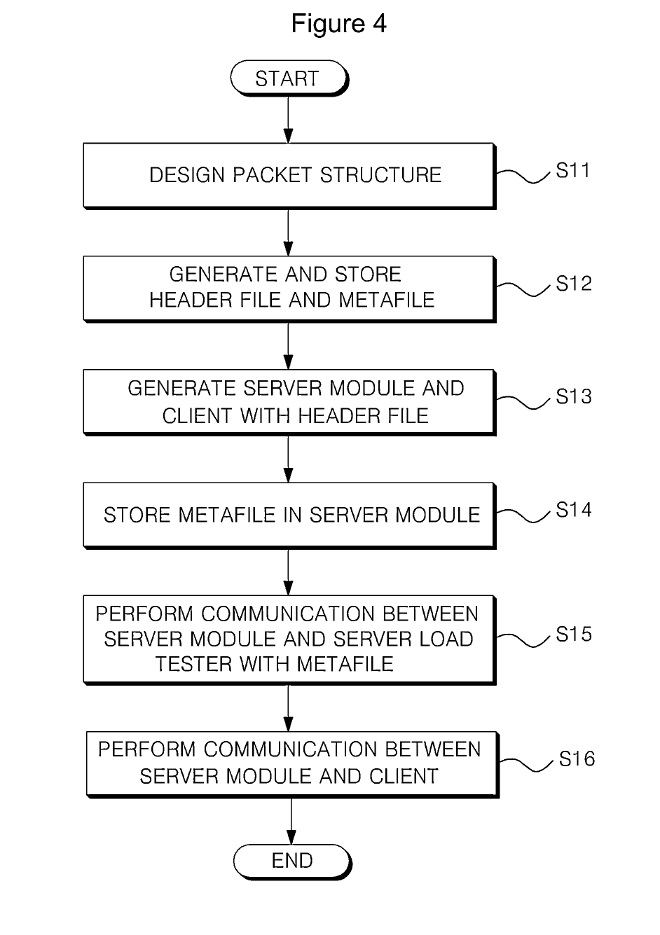

A providing method of the server-test integrated apparatus 100 for online game will be described below with reference to FIG. 4.

Referring to FIG. 4, a user first designs a packet structure for generating the server module 110 with the packet designer tool 120 in operation S11. In this case, the packet designer tool 120 is designed based on a label and type that are inputted through a user interface such as a GUI as in FIG. 2.

Subsequently, the packet designer tool 120 is converted into a header file 112 of C/C++ necessary in generating the server module 110 with the designed packet structure and a metafile 111 for a load test, and the header file 112 and metafile 111 are respectively stored in the header file processor 20 and the metafile processor 130 in operation S12. Herein, the header file processor 20 is not included in the server-test integrated apparatus 100 for online game, but is used in defining a packet protocol when the client 10 accesses the server module 110.

In the embodiment, the metafile 111 uses XML, but is not limited thereto and includes all definition files enabling the definition of a packet.

Subsequently, the server-test integrated apparatus 100 generates the server module 110 and the client 10 that enables a user to access the server module 110 and play a game, with the header file 112 generated by the packet designer tool 120 in operation S13.

Accordingly, a structure of a packet is designed with the packet designer tool 120, and thus, a load test is easily performed for all server modules that are generated as game servers.

The packet designer tool 120 stores the generated metafile 111 in the server module 110, for matching the server load tester 141 and packet information in operation S14. In this case, the metafile 111 stored in the server module 110 may be received from the metafile processor 130.

Herein, the server load tester 140 may define a packet with the metafile 111 that is stored as a complied program, and load tests for various games may be performed with the metafiles 111 for the various games.

The server module 110 and the server load tester 140 communicate with each other according to an integrated packet protocol in operation S15. In this case, the server load tester 140 may test the load of the server module 110 through packet communication.

Finally, the server load tester 140 ends a load test, and the client 10 having the same packet as that of the server module 110 accesses the server module 110 and plays a game in operation S16.

In this case, at least one or more clients 10 may simultaneously access the server module 110.

According to the embodiments, accordingly, a packet is designed with the packet designer tool 120 before the server module 110 is manufactured irrespective of the kinds of games, and thus, a server load can be easily tested by the server load tester 140, thereby enabling the wide use of the server-test integrated apparatus 100.

As described above, the server-test integrated apparatus according to the embodiments can easily perform a load test with a packet protocol that has been generated when designing the server module, and widely perform a test by generating a packet protocol corresponding to each of various game servers when producing the various game servers.

Moreover, the server-test integrated apparatus according to the embodiments can be applied to a test for the performance and stability of an online game server, thus saving the cost and time expended in the test.

Although the server-test integrated apparatus for online game has been described with reference to the specific embodiments, it is not limited thereto. Therefore, it will be readily understood by those skilled in the art that various modifications and changes can be made thereto without departing from the spirit and scope of the present invention defined by the appended claims.

What is claimed is:

1. A server-test integrated apparatus for online game, comprising:
a server module providing online service to a client over a network;
a server load tester writing a scenario to test a load of the server module;
a packet designer tool defining a packet protocol, and generating a header file for exchanging data between the server module and the client, and at least one packet definition file for exchanging data between the server module and server load tester; and
a metafile processor storing the packet definition file generated by the packet designer tool,
wherein the server load tester writes the scenario using the packet definition file.

2. The server-test integrated apparatus of claim 1, wherein the packet designer tool defines a label, a type of the label, and a packet length of the type.

3. The server-test integrated apparatus of claim 1, wherein the header file generated by the packet designer tool is stored in a header file processor.

4. The server-test integrated apparatus of claim 1, wherein the server module receives the header file for accessing the client and the packet definition file for accessing the server load tester, from the packet designer tool.

5. The server-test integrated apparatus of claim 1, wherein the server load tester comprises:
a script generation unit generating a scenario script with a defined packet;
a storage unit storing the generated scenario script; and
a load generation unit generating a virtual client to generate the load of the server module, according to the scenario script.

6. The server-test integrated apparatus of claim 5, wherein the scenario script is generated by combining the packet definition files.
